(19) United States
(12) Patent Application Publication
(10) Pub. No.: US 2026/0028153 A1
(43) Pub. Date: Jan. 29, 2026

(54) ATOMIZING SPORTS BOTTLE WITH CONCEALED WATER SUPPLY TUBE

(71) Applicant: Shenzhen Ruibiao Trade Co., Ltd., Shenzhen (CN)

(72) Inventor: Junlin Qin, Shenzhen (CN)

(21) Appl. No.: 19/341,561

(22) Filed: Sep. 26, 2025

Related U.S. Application Data
(63) Continuation of application No. PCT/CN2024/130353, filed on Nov. 7, 2024.

(30) Foreign Application Priority Data
Mar. 22, 2024 (CN) 202410333201.7

(51) Int. Cl. B65D 23/04; A45F 3/18; B05B 7/04; B65D 47/08; B65D 51/18; B65D 53/02

(52) U.S. Cl. CPC B65D 23/04; B05B 7/04; B65D 47/08; B65D 51/18; B65D 53/02; A45F 3/18

(57) ABSTRACT

The invention provides an atomizing sports bottle with a concealed water supply tube, comprising a bottle body and a main lid. A liner is arranged inside the bottle body. A vacuum layer is arranged between the bottle body and the liner. The water supply tube is arranged inside a vacuum layer. A water outlet hole is provided at the bottle mouth, while the liner is provided with a water supply hole. One end of the water supply tube is connected to the water supply hole, and the other end thereof is connected to the water outlet hole. The bottle body features a vacuum inner layer with a concealed tube, addressing the limitations of traditional water bottles that rely on long tubes and reducing the risk of secondary contamination during disassembly, assembly, and water refilling processes.

### TECHNICAL FIELD

The present application relates to the field of atomizing water bottles, particularly to an atomizing sports bottle with a concealed water supply tube.

### BACKGROUND ART

Nowadays, water bottles are designed with an increasing number of auxiliary functions. Among them, those with an atomizing function are particularly popular, as they can spray water to provide cooling, humidify the air, and moisturize the skin. The atomizing water bottles in the prior art include both electric atomizing and push-type atomizing bottles. Electric atomizing water bottles are widely used due to their ease of use.

However, existing electric atomizing water bottles require a water supply tube to be installed in the lid, which makes disassembly inconvenient. After disassembly, the water supply tube interferes with the proper placement of the lid, particularly during outdoor use. This interference increases the risk of secondary contamination. To resolve these technical issues, an atomizing sports bottle with a concealed water supply tube is proposed.

### SUMMARY OF THE INVENTION

The purpose of the present application is to address the technical issue of secondary contamination, which easily occurs in the water supply tubes of existing atomizing bottles. Compared with the prior art, this application provides an atomizing sports bottle with a concealed water supply tube. The bottle comprises a bottle body and a main lid. A secondary lid is further arranged positioned on the top of the main lid. A liner is arranged inside the bottle body, and a vacuum layer is formed between the bottle body and the liner. The water supply tube is arranged inside the vacuum layer. A water outlet hole is arranged on the top of a bottle mouth of the bottle body, while a water supply hole is arranged on one side of the bottom of the liner. The input end of the water supply tube is connected to the water supply hole, and the output end thereof is connected to the water outlet hole.

An upper seal housing and a lower seal housing are arranged inside the main lid. A control circuit board, a water pump, and a battery are encapsulated between the upper seal housing and the lower seal housing. A bottom housing is further arranged at the bottom of the lower seal housing, with its base connected to the bottle mouth through a threaded structure. A seal ring is further arranged at the base of the bottom housing. A mating groove is arranged at the bottom of the seal ring. A matched water supply ring is embedded in the mating groove. A water supply ring groove is arranged at the bottom of the water supply ring. Meanwhile, a water supply connector is arranged on top of the water supply ring and connected with the water supply ring groove.

A drinking spout is arranged on the top of the main lid, coaxial with the liner and connected to its interior. The main lid is connected to the drinking spout through a threaded structure. An atomizing nozzle is arranged on one side of the top of the secondary lid. An abutting joint is arranged on the top of the drinking spout, with its output end connected to the input end of the atomizing nozzle. The input end of the water pump is connected to the water supply connector through a hose, while the output end thereof is connected to the abutting joint via a hose.

Further, the water supply tubes can be categorized into C-shaped tubes (a) or circular tubes (b) based on production requirements. The C-shaped tube (a) has an open-structured, C-shaped cross-section, while the circular tube (b) has a closed-structured, circular cross-section.

Further, the open side of the C-shaped tube (a) is integrally welded to the liner. The two ends of the C-shaped (a) are respectively welded to the water supply hole and the water outlet hole. Meanwhile, the two ends of the circular tube (b) are also respectively welded to the water supply hole and the water outlet hole.

Further, the seal ring adopts a flexible ring-body structure with a plurality of fixing holes evenly arranged on the seal ring. The water supply ring has a rigid ring-body structure, with anchor columns aligned with the fixing holes positioned on top of it. The top ends of the anchor columns pass through the fixing holes and are secured to the base of the bottom housing.

Further, a ring-shaped part is fixed at the bottom of the secondary lid through a clip structure and has a ring-shaped structure with an H-shaped cross-section. A groove is arranged at the bottom of the ring-shaped part, and a seal is further arrangedon top of the main lid to fit into the groove.

Further, a flexible pad is fixed in the groove at the bottom of the ring-shaped part. A plurality of sealing flanges are arranged at equal intervals along the inner and outer sides of the circular ring of the seal. A filter screen is also fixed at the abutting joint.

Further, a mixing chamber fitting with the drinking spout is arranged on the upper seal housing. Two sets of diversion channels are symmetrically arranged at the bottom of the mixing chamber, while two corresponding sets of diversion interfaces are arranged on the bottom housing. The diversion channels are connected to the diversion interfaces, with a first sealing gasket clamped between each diversion channel and its respective diversion interface. The drinking spout is internally connected to the liner through the mixing chamber and the diversion channels.

Further, a one-way air valve is also arranged at the connection between the bottom housing and the lower seal housing, between two sets of diversion interfaces, to unidirectionally supply air to the liner.

Further, a C-shaped handle is arranged on one side of the main lid. The secondary lid is rotatably connected to a retaining ring. A hook buckle is rotatably connected to one side of the retaining ring and sleeved on the C-shaped handle of the main lid. Additionally, a second sealing gasket matched with the drinking spout is fixed inside the secondary lid.

Further, a charging port and a power switch are also arranged on the secondary lid. The charging port, power switch, water pump, and battery are all electrically connected to the control circuit board through wires.

Compared to the prior art, the present application offers the following advantages:

The invention features a vacuum inner layer with a concealed tube, addressing the limitations of traditional sports bottles that rely on long external water tubes and significantly reducing the risk of secondary contamination during disassembly, reassembly, and refilling processes. Furthermore, the invention has a rapid leak-proof design for convenient and efficient lid closure. With wide applicability across various usage scenarios, the invention demonstrates strong market potential and is well-suited for popularization and application.

### BRIEF DESCRIPTION OF THE DRAWINGS

FIG. 1 is a structural diagram of the present application.

FIG. 2 is a structural diagram of the bottle body and the main lid proposed in the present application in a separated state.

FIG. 3 is a schematic diagram of the cross-section structure of the bottle body proposed in the present application.

FIG. 4 is a structural diagram of the C-shaped tube and the circular tube proposed in the present application.

FIG. 5 is a state comparison diagram of the secondary lid proposed in the present application before and after opening and closing.

FIG. 6 is an exploded structural diagram of the secondary lid proposed in the present application.

FIG. 7 is an exploded structural diagram of the main lid proposed in the present application.

FIG. 8 is a schematic diagram of the front and bottom structures of the upper seal housing proposed in the present application.

FIG. 9 is an exploded structural diagram of the bottom housing proposed in the present application.

FIG. 10 is a cross-sectional structural diagram of the seal ring and water supply ring proposed in the present application.

FIG. 11 is a partial cross-sectional structural diagram of the present application.

FIG. 12 is an enlarged structural diagram of Part A in FIG. 11.

FIG. 13 is an enlarged structural diagram of Part B in FIG. 11.

FIG. 14 is a schematic diagram of the installation position of the one-way air valve proposed in the present application.

### REFERENCE SIGNS

Bottle body 1, liner 11, water supply hole 111, bottle mouth 12, water outlet hole 121; main lid 2, charging port 201, power switch 202, drinking spout 21, seal 22, abutting joint 221, filter screen 222, sealing flange 223, upper seal housing 23, mixing chamber 231, diversion channel 232, lower seal housing 24, bottom housing 25, diversion interface 251, first sealing gasket 252, one-way air valve 26, water supply tube 3, C-shaped tube 3a, circular tube 3b, secondary lid 4, atomizing nozzle 41, ring-shaped part 42, flexible pad 421, retaining ring 43, hook buckle 431, second sealing gasket 44, control circuit board 5, water pump 6, battery 7, seal ring 8, mating groove 81, fixing hole 82, water supply ring 9, water supply interface 91, water supply ring slot 92, anchor column 93.

### DETAILED DESCRIPTION OF THE INVENTION

The technical proposals of the embodiments are clearly and fully described below in conjunction with the drawings of the specification. According to the embodiments of the present application, all other embodiments obtained by those skilled in the art without creative efforts shall fall within the protection scope of the present application.

### Embodiment 1

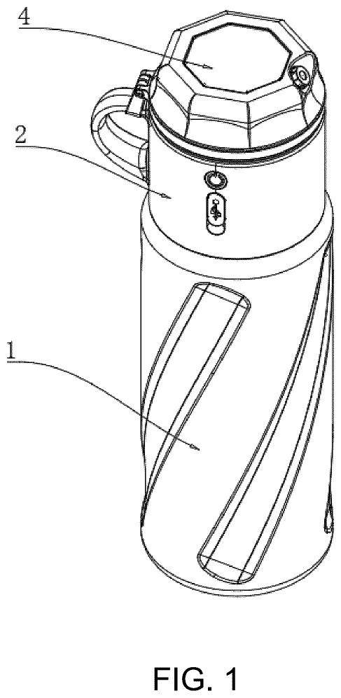

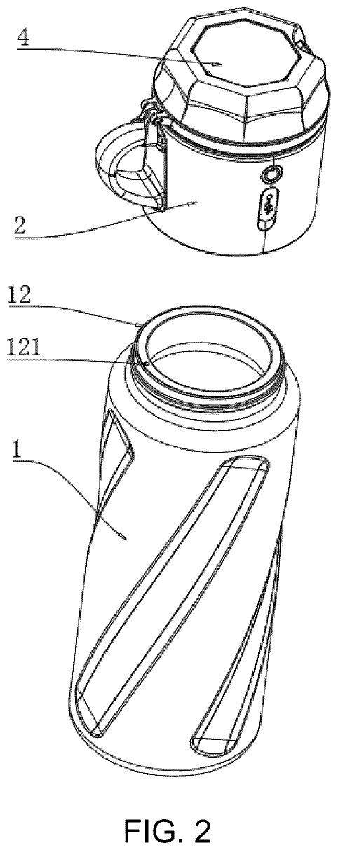

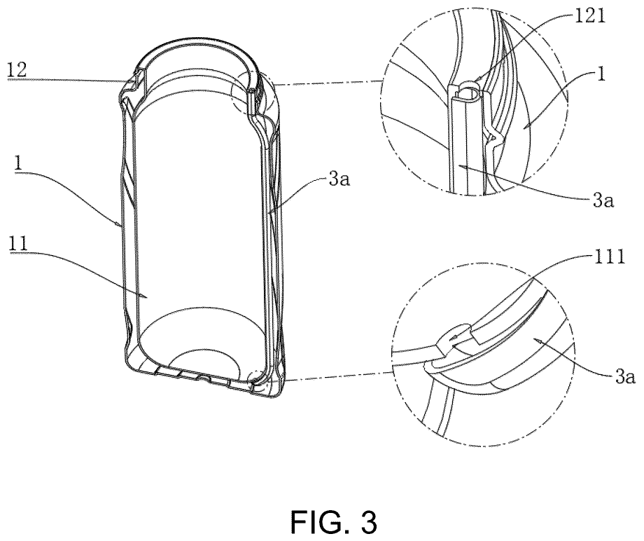

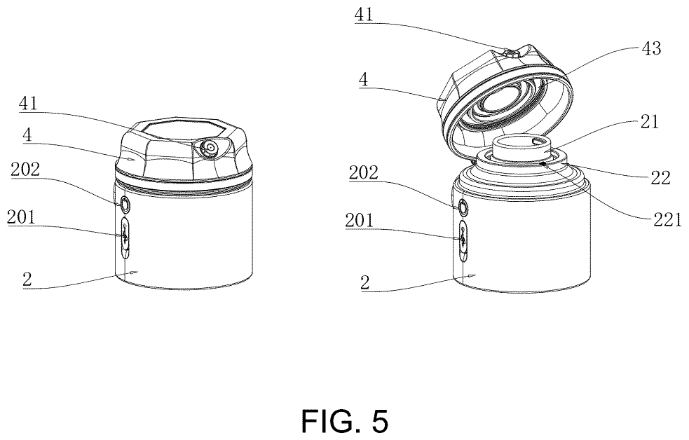

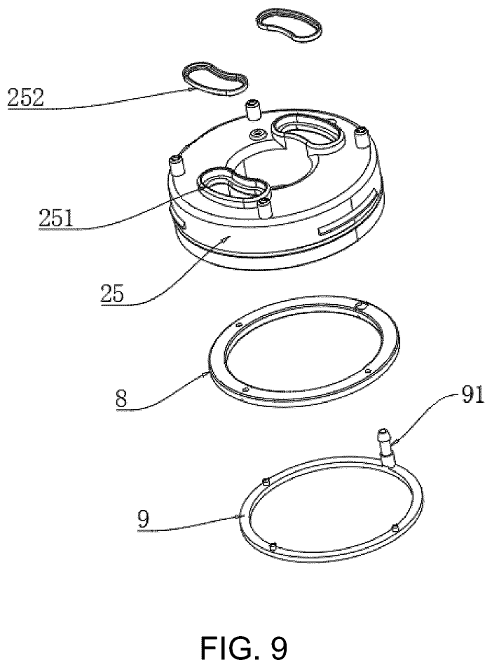

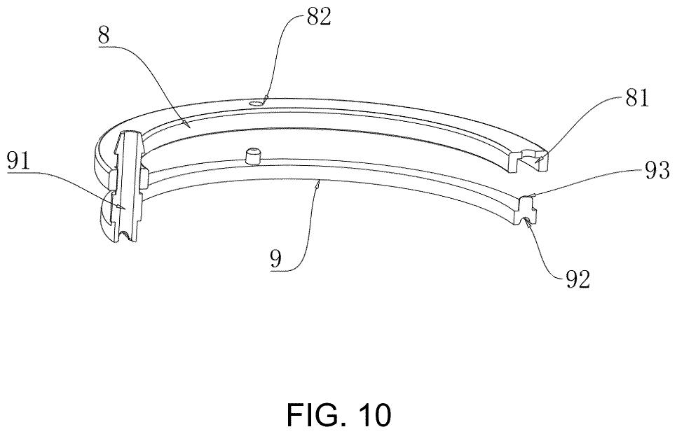

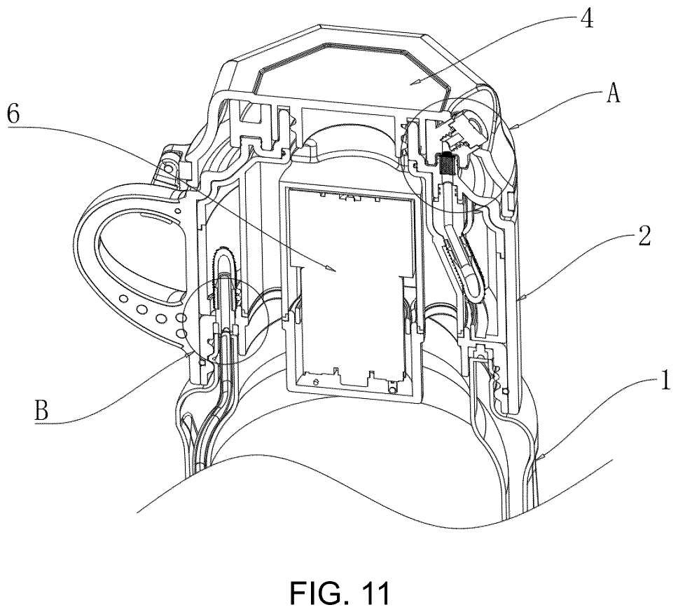

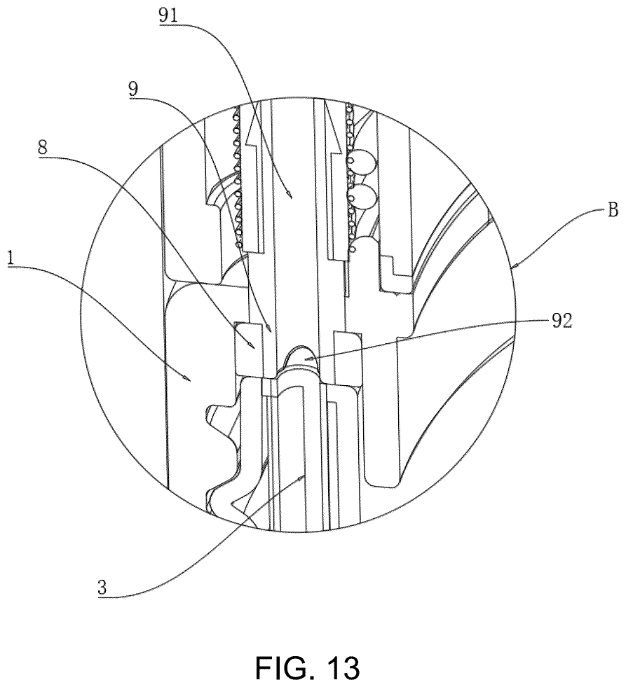

The invention provides an atomizing sports bottle with a concealed water supply tube, as shown in FIGS. 1-14, comprising a bottle body (1) and a main lid (2). A secondary lid (4) is further arranged on top of the main lid (2). A liner (11) is positioned inside the bottle body (1). The bottle body (1) is made of (304) stainless steel or (316) stainless steel. A vacuum layer is arranged between the bottle body (1) and the liner (11) to effectively maintain the heat insulation effect of the bottle body (1). A concealed water supply tube (3) is arranged inside the vacuum layer. The specific concealed installation method of the water supply tube (3) is as follows: a water outlet hole (121) is arranged at the top of a bottle mouth (12) of the bottle body (1), while a water supply hole (111) is arranged on one side of the bottom of the liner (11). The input end of the water supply tube (3) is connected to the water supply hole (111), and the output end thereof is connected to the water outlet hole (121).

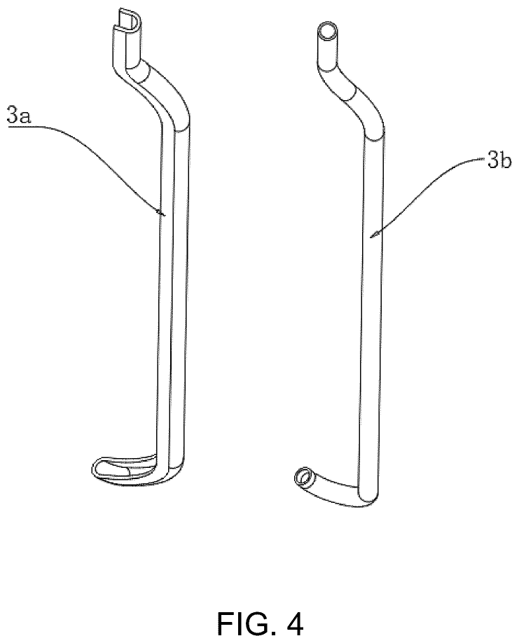

As shown in FIG. 4, the water supply tube 3 can be categorized into a C-shaped tube (3a) and a circular tube (3b) based on production requirements. The C-shaped tube (3a) has an open-structured, C-shaped cross-section, while the circular tube (3b) has a closed-structured, circular cross-section. The open side of the C-shaped tube (3a) is integrally laser-welded to the liner (11). The two ends of the C-shaped tube (3a) are laser-welded to the water supply hole (111) and the water outlet hole (121), respectively. Meanwhile, the two ends of the circular tube (3b) are also laser-welded to the water supply hole (111) and the water outlet hole (121), respectively. Before assembling the bottle body (1) and the liner (11), waterproof testing must be conducted on the weld seams at the welding positions of either the C-shaped tube (3a) or the circular tube (3b) to ensure sealing performance.

Compared to the existing water bottle structure with a suction tube on the bottle lid, the present application adopts a concealed water supply tube (3) design, effectively preventing water pollution caused by the exposure of the suction tube when the traditional bottle lid is removed. In addition, unlike existing bottle lid designs, the main lid (2) has no protruding structure at the bottom, allowing it to be placed horizontally. This makes water refilling easier for users, avoids the tilting problem common in traditional bottle lids due to the protruding suction tubes, and prevents secondary contamination after the lid is closed. Furthermore, the absence of a protruding structure and suction tube at the bottom of the main lid (2) effectively increases the internal capacity of the liner (11), thereby enhancing water storage capacity.

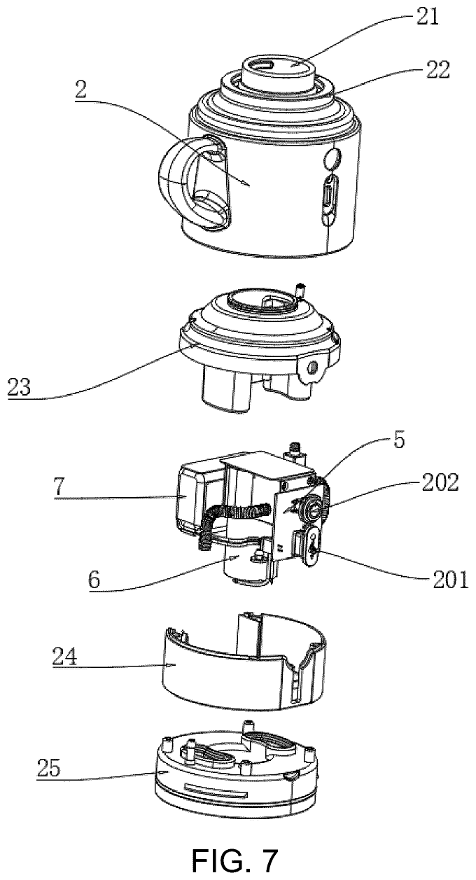

As shown in FIGS. 7-10, in this embodiment, an upper seal housing (23) and a lower seal housing (24) are positioned inside the main lid (2). A control circuit board (5), a water pump (6), and a battery (7) are encapsulated between the upper seal housing (23) and the lower seal housing (24). A charging port (201) and a power switch (202) are further arranged on the secondary lid (4). The charging port (201), the power switch (202), the water pump (6), and the battery (7) are electrically connected to the control circuit board (5) through wires.

A bottom housing (25) is further arranged at the bottom of the lower seal housing (24). The base of the bottom housing (25) is connected to the bottle mouth (12) through a threaded structure. A seal ring (8) is further arranged at the base of the bottom housing (25). A mating groove (81) is arranged at the bottom of the seal ring (8). A matched water supply ring (9) is embedded in the mating groove (81). A water supply ring groove (92) is arranged at the bottom of the water supply ring (9). Meanwhile, a water supply connector (91) is arranged on top of the water supply ring (9) and connected with the water supply ring groove (92). The seal ring (8) adopts a flexible ring body structure, a plurality of fixing holes (82) arranged at equal angles on the seal ring (8). The water supply ring (9) adopts a rigid ring body structure. Anchor columns (93) matched with the fixing holes (82) are arranged on the top of the water supply ring (9). The top end of the anchor column (93) passes through the fixing hole (82) and is fixed at the base of the bottom housing (25).

By using the water supply ring (9) with the water supply ring groove (92) and the seal ring (8) with the mating groove (81), the water supply interface (91) is not required to be aligned with the water outlet hole (121). In other words, the main lid (2) does not need to be fully tightened onto the bottle mouth (12). Instead, only pressure from the main lid (2) is needed to compress the seal ring (8) against the bottle mouth (12) for sealing. When the water pump (6) provides pumping power to the water supply interface (91), water stored in the liner (11) flows through the water supply ring groove (92) into the water supply tube (3) and then into the water supply interface (91) from the water supply ring groove (92) to achieve a continuous water supply path. This path effectively improves the error tolerance rate of the main lid (2) during tightening, reduces the precision requirements for the thread processing of the bottle mouth (12), and enhances processing efficiency.

As shown in FIGS. 7-9, a drinking spout (21) is positioned at the top of the main lid (2) and is coaxial with the liner (11). The centralized design of the drinking spout (21) eliminates the drawback of traditional sports bottles, which require users to drink from a specific direction. The drinking spout (21) is internally connected to the liner (11), while the main lid (2) is connected to the drinking spout (21) through a threaded structure. An atomizing nozzle (41) is positioned on one side of the secondary lid (4) and recessed into it, reducing the risk of damage upon impact and thereby extending its service life. An abutting joint (221) is positioned at the top of the drinking spout (21), with its output end connected to the input end of the atomizing nozzle (41). The input end of the water pump (6) is connected to the water supply connector (91) through a hose, while the output end of the water pump (6) is connected to the abutting joint (221) through another hose.

Water is pumped from the liner (11) by the water pump (6) through the water supply tube (3), then pressurized and delivered to the atomizing nozzle (41). After exercise, users can either utilize the mist sprayed from the atomizing nozzle (41) for rapid surface cooling or drink directly from the drinking spout (21), providing a multifunctional design that meets various post-exercise needs.

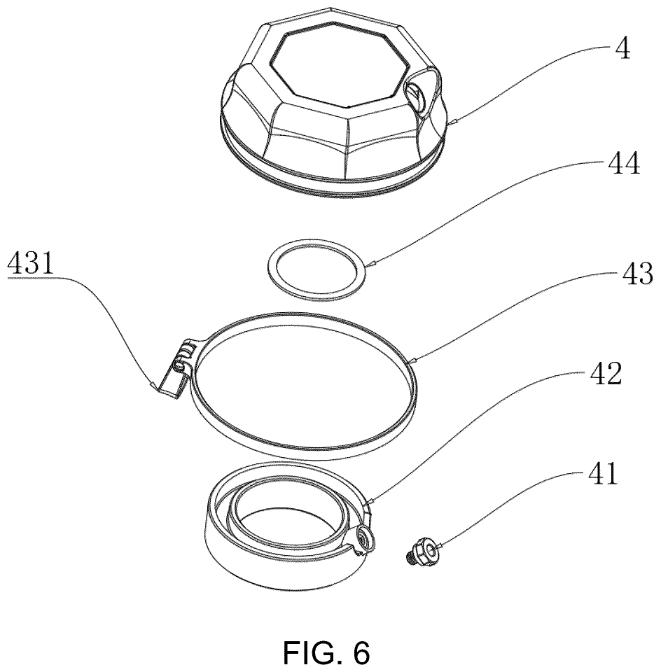

As shown in FIGS. 6-12, a ring-shaped part (42) is fixed to the bottom of the secondary lid (4) using a clip structure and adopts a ring-shaped structure with an H-shaped cross-section. A groove is positioned at the bottom of the ring-shaped part (42), while a seal (22) is further arranged on top of the main lid (2) to fit into the groove at the bottom of the ring-shaped part (42). In addition, a flexible pad (421) is fixed in the groove at the bottom of the ring-shaped part (42). A plurality of sealing flanges (223) are arranged at equal intervals along the inner and outer sides of the circular ring of the seal (22). A filter screen (222) is also fixed at the abutting joint (221). The design of the filter screen (222) effectively prevents water impurities from clogging the atomizing nozzle (41), further extending the service life of the atomizing nozzle (41).

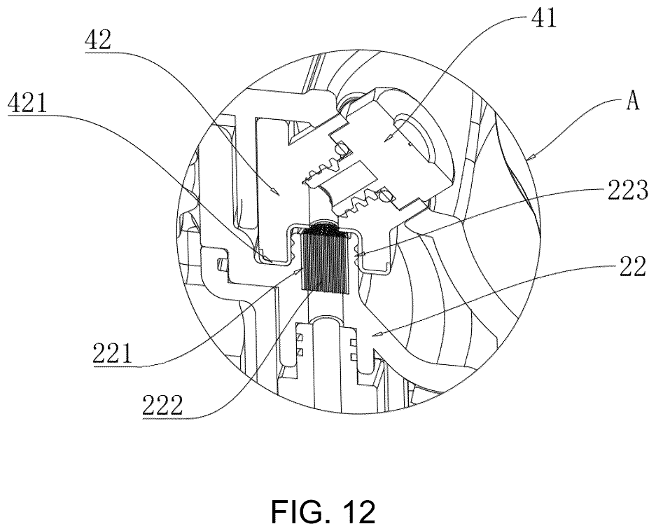

As shown in FIG. 12, by adopting the seal (22) with its sealing flange and the ring-shaped part (42) with a flexible pad (421), the ring-shaped part (42) is pressed against the sealing flange (223) when the secondary lid (4) is not fully tightened onto the drinking spout (21) of the main lid (2). The sealing flange (223) compresses the flexible pad (421) to form a piston structure that maintains the sealing performance of the drinking spout (21). This enables quick closure of the drinking spout (21) in sports scenarios and enhances overall usability.

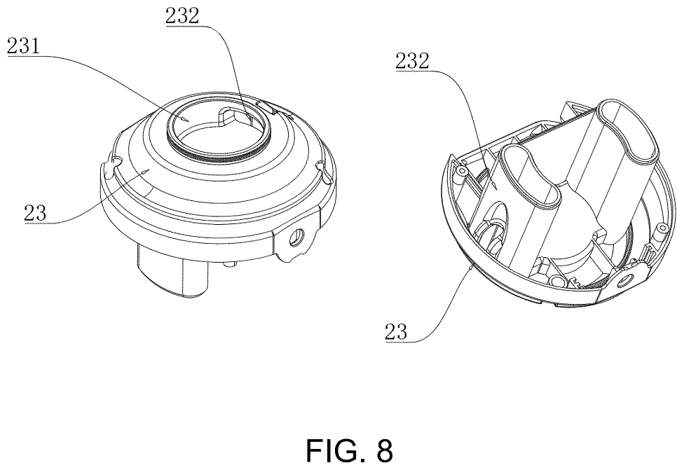

As shown in FIGS. 8-10, a mixing chamber (231) fitted with the drinking spout (21) is arranged on the upper seal housing (23). Two sets of diversion channels (232) are symmetrically arranged at the bottom of the mixing chamber (231), while two sets of diversion interfaces (251) are arranged on the bottom housing (25). The diversion channels (232) are connected to the diversion interfaces (251). a first sealing gasket (252) is also clamped between the diversion channel (232) and the diversion interface (251). The drinking spout (21) is internally connected to the liner (11) through the mixing chamber (231) and the diversion channel (232).

Two sets of symmetrical diversion channels (232) and a centralized drinking spout (21) allow users to drink water from any direction. Additionally, when the water level in the bottle is low, the diversion channels (232) guide the remaining water to the spout (21), eliminating the need to increase the drinking angle and further enhancing usability.

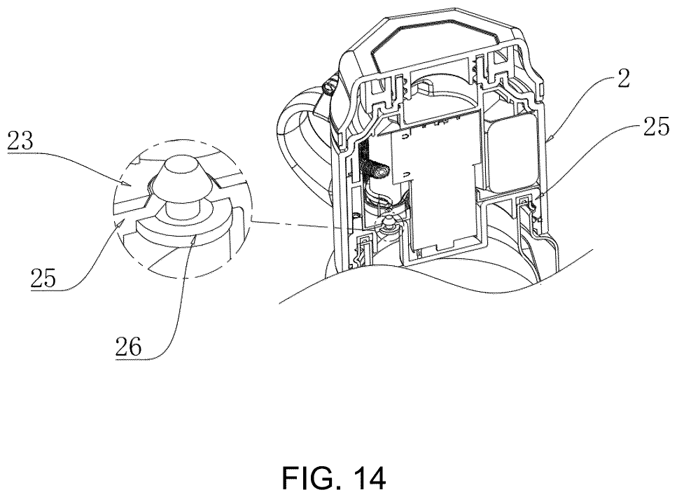

As shown in FIG. 14, to prevent the liner (11) from generating negative pressure due to continuous pumping under sealed conditions-which would increase the difficulty of pumping water-a one-way air valve (26) is also arranged at the connection between the bottom housing (25) and the lower seal housing (24), is arranged between two sets of diversion interfaces (251) and unidirectionally supplies air to the liner (11). During the water pumping process, the one-way air valve (26) connects the liner (11) to the outside, thereby maintaining stable pumping performance.

It should be noted that a C-shaped handle is arranged on one side of the main lid (2) for easy carrying. The secondary lid (4) is rotatably connected to a retaining ring (43). A hook buckle (431) is rotatably connected to one side of the retaining ring (43) and sleeved on the C-shaped handle of the main lid (2). A second sealing gasket (44) matched with the drinking spout (21) is also fixed inside the secondary lid (4). The combination of the retaining ring (43) and the hook buckle (431) ensures that the secondary lid (4) is less likely to fall off while being rotated or flipped, thus preventing loss during use.

The invention features a vacuum inner layer with a concealed tube, addressing the limitations of traditional sports bottles that rely on long external water tubes and significantly reducing the risk of secondary contamination during disassembly, reassembly, and refilling processes. Additionally, the invention adopts a rapid leak-proof design that enables convenient and efficient lid closure. With broad applicability across various usage scenarios, the invention demonstrates strong market potential and is well-suited for popularization and application.

The above descriptions represent the preferred embodiments of the present application, tailored to current practical needs. However, the scope of protection of the present application is not limited to these embodiments.

1. An atomizing sports bottle with a concealed water supply tube comprising a bottle body (1) and a main lid (2), wherein a secondary lid (4) is further arranged on the top of the main lid (2), a liner (11) is arranged inside the bottle body (1), a vacuum layer is arranged between the bottle body (1) and the liner (11), a water supply tube (3) is arranged inside the vacuum layer, a water outlet hole (121) is arranged on the top of a bottle mouth (12) of the bottle body (1), a water supply hole (111) is arranged on one side of the bottom of the liner (11), the input end of the water supply tube (3) is connected to the water supply hole (111), and the output end thereof is connected to the water outlet hole (121);
an upper seal housing (23) and a lower seal housing (24) are arranged inside the main lid (2), a control circuit board (5), a water pump (6) and a battery (7) are encapsulated between the upper seal housing (23) and the lower seal housing (24), a bottom housing (25) is further arranged at the bottom of the lower seal housing (24), the bottom of the bottom housing (25) is connected to the bottle mouth (12) through a threaded structure, a seal ring (8) is further arranged at the bottom of the bottom housing (25), a mating groove (81) is arranged at the bottom of the seal ring (8), a matched water supply ring (9) is embedded in the mating groove (81), a water supply ring groove (92) is arranged at the bottom of the water supply ring (9), and a water supply connector (91) is arranged on top of the water supply ring (9) and connected with the water supply ring groove (92);
a drinking spout (21) is arranged on the top of the main lid (2), coaxial with the liner (11) and connected to the inside of the liner (11), the main lid (2) connected to the drinking spout (21) through a threaded structure, an atomizing nozzle (41) is arranged on one side of the top of the secondary lid (4), an abutting joint (221) is arranged on the top of the drinking spout (21), the output end of the abutting joint (221) is connected to the input end of the atomizing nozzle (41), the input end of the water pump (6) is connected to the water supply connector (91) through a hose, and the output end of the water pump (6) is connected to the abutting joint (221) through a hose.

2. The atomizing sports bottle with the concealed water supply tube according to claim 1, wherein the water supply tube (3) can be categorized as either a C-shaped tube (3a) or a circular tube (3b) based on production requirements, the cross-section of the C-shaped tube (3a) has an open structure with a C-shaped cross-section, and the circular tube (3b) has a closed structure with a circular cross-section.

3. The atomizing sports bottle with the concealed water supply tube according to claim 2, wherein the open side of the C-shaped tube (3a) is integrally welded to the liner (11), the two ends of the C-shaped (3a) are respectively welded to the water supply hole (111) and the water outlet hole (121), and the two ends of the circular tube (3b) are respectively welded to the water supply hole (111) and the water outlet hole (121).

4. The atomizing sports bottle with the concealed water supply tube according to claim 1, wherein the seal ring (8) adopts a flexible ring body structure, a plurality of fixing holes (82) are arranged at equal angles on the seal ring (8), the water supply ring (9) adopts a rigid ring body structure, anchor columns (93) matched with the fixing holes (82) are arranged on top of the water supply ring (9), and the top end of the anchor column (93) passes through the fixing hole (82) and is fixed at the base of the bottom housing (25).

5. The atomizing sports bottle with the concealed water supply tube according to claim 1, wherein a ring-shaped part (42) is fixed at the bottom of the secondary lid (4) using a clip structure and adopts a ring-shaped structure with an H-shaped cross-section, a groove is arranged at the bottom of the ring-shaped part (42), and a seal (22) is further arranged on top of the main lid (2) and fits with the groove at the bottom of the ring-shaped part (42).

6. The atomizing sports bottle with the concealed water supply tube according to claim 1, wherein a flexible pad (421) is fixed in the groove at the bottom of the ring-shaped part (42), a plurality of sealing flanges (223) are arranged at equal intervals on the inner and outer sides of the circular ring of the seal (22), and a filter screen (222) is also fixed in the abutting joint (221).

7. The atomizing sports bottle with the concealed water supply tube according to claim 1, wherein a mixing chamber (231) fitting with the drinking spout (21) is arranged on the upper seal housing (23), two groups of diversion channels (232) are symmetrically arranged at the bottom of the mixing chamber (231), two groups of diversion interfaces (251) are arranged on the bottom housing (25), the diversion channels (232) are connected to the diversion interfaces (251), a first sealing gasket (252) is also clamped between the diversion channel (232) and the diversion interface (251), and the drinking spout (21) is internally connected to the liner (11) through the mixing chamber (231) and the diversion channel (232).

8. The atomizing sports bottle with the concealed water supply tube according to claim 7, wherein a one-way air valve (26) is also arranged at the connection between the bottom housing (25) and the lower seal housing (24), is arranged between two groups of diversion interfaces (251) and unidirectionally supplies air to the liner (11).

9. The atomizing sports bottle with the concealed water supply tube according to claim 1, wherein a C-shaped handle is arranged on one side of the main lid (2), the secondary lid (4) is rotatably connected with a retaining ring (43), a hook buckle (431) is rotatably connected to one side of the retaining ring (43) and sleeved on the C-shaped handle of the main lid (2), and a second sealing gasket (44) matched with the drinking spout (21) is also fixed inside the secondary lid (4).

10. The atomizing sports bottle with the concealed water supply tube according to claim 1, wherein a charging port (201) and a power switch (202) are further arranged on the secondary lid (4), and the charging port (201), the power switch (202), the water pump (6) and the battery (7) are electrically connected to the control circuit board (5) through wires.
